(19) United States
(12) Patent Application Publication
(10) Pub. No.: US 2025/0320574 A1
(43) Pub. Date: Oct. 16, 2025

(54) PREPARATION METHOD FOR WELDED AND EXTENDED SUPER DUPLEX STAINLESS STEEL SEAMLESS PIPE COIL FOR DEEP-SEA UMBILICAL CABLE

(71) Applicant: Jiangsu Wujin Stainless Steel Pipe Group Co., Ltd., Changzhou (CN)

(72) Inventor: Hong Gao, Changzhou (CN)

(21) Appl. No.: 18/961,443

(22) Filed: Nov. 26, 2024

(30) Foreign Application Priority Data
Apr. 15, 2024 (CN) 202410447142.6

(51) Int. Cl. C21D 9/08; C21D 6/00; C21D 8/10; C22C 38/00; C22C 38/02; C22C 38/04; C22C 38/44

(52) U.S. Cl. CPC C21D 9/08; C21D 6/004; C21D 8/105; C22C 38/001; C22C 38/002; C22C 38/02; C22C 38/04; C22C 38/44; C21D 2211/001; C21D 2211/005

(57) ABSTRACT

The invention discloses a preparation method for a welded and extended super duplex stainless steel seamless pipe coil for a deep-sea umbilical cable. An AOD furnace, Al deoxidation, calcium treatment and external refining are adopted to ensure that the oxygen content in steel is at most 25 ppm. The key technology of integrated cold deformation control for hot piercing high-temperature intermediate solution heat treatment, deformation quantity and distribution is adopted. As stated above, the preparation method for a welded and extended super duplex stainless steel seamless pipe coil for a deep-sea umbilical cable according to the invention can meet the standards for deep-sea oil and gas production and use and ensure that the coil has high mechanical properties, good pitting resistance, and is suitable for a harsh seawater application medium environment in deep-sea water.

### CROSS-REFERENCE TO RELATED APPLICATION

The present application claims priority from Chinese Patent Application No. 202410447142.6 filed on Apr. 15, 2024, the contents of which are incorporated herein by reference in their entirety.

### BACKGROUND OF THE INVENTION

### 1. Technical Field

The present invention relates to the field of stainless steel pipes and, in particular, to a preparation method for a welded and extended super duplex stainless steel seamless pipe coil for a deep-sea umbilical cable.

### 2. Description of Related Art

With the continuous deepening of deep-sea oil and gas resource exploitation, it gradually extends from shallow water to deep water. The development of deepwater oil and gas fields is faced with long offshore distance, poor marine environment conditions (internal waves and typhoons), complex seafloor terrain with large elevation difference and low-temperature and high-pressure environment, complex reservoir characteristics (high temperature, high pressure), so a subsea production system has become the main form of deep-sea oil and gas field exploitation. As a key facility connecting subsea oil and gas production systems such as a subsea tree, a subsea manifold and a subsea control module, the subsea umbilical cable is usually composed of cables, optical cables and duplex stainless steel pipes for hydraulic control, oil, water, gas and chemical agents and is a key component of the subsea production system.

As a core pipeline for transporting chemical agents and hydraulic fluids in the subsea umbilical cable, the duplex stainless steel pipe serves under extremely harsh conditions: to serve stably under water for more than 20 years, the duplex stainless steel pipe must withstand the fluctuating stress and strain caused by a non-fixed platform and the hydraulic loads of 34.5 Mpa and 68.9 MPa, and also has to withstand the erosion of chloride ion in seawater and various oil, gas and chemical agents. For connecting the oil production platform to subsea wellheads, a umbilical cable pipe often has a length of thousands of meters, or even tens of kilometers, and the seamless pipe needs to be connected and extended by welding. In order to meet the requirements of high reliability and high security in the whole life cycle, duplex stainless steel grades currently used are generally S32750 and S31803.

With the development of oil and gas resources from shallow water to deep water, the corrosive pitting equivalent of S31803 duplex stainless steel=22% Cr+3.3×3% Mo+16×0.15% N=34.3, the pitting resistance is relatively insufficient, and due to the low content of main alloying elements Cr, Ni, Mo, N, etc., the mechanical properties are relatively low and cannot be further improved by fine-tuning the alloying elements. S32750 can meet the needs of the current umbilical cable pipe, but with the expansion of oil and gas exploitation to deeper waters, on the basis of this brand, it is desired to provide a welded and extended super duplex stainless steel seamless pipe coil for a deep-sea umbilical cable with improved mechanical and pitting resistance, excellent fatigue performance and chloride ion pitting resistance and a preparation method therefor.

### BRIEF SUMMARY OF THE INVENTION

The present invention mainly solves the technical problem of providing a preparation method for a welded and extended super duplex stainless steel seamless pipe coil for a deep-sea umbilical cable, which can meet the standards for deep-sea oil and gas production and use and ensure that the coil has high mechanical properties, good pitting resistance, and is suitable for the harsh seawater application medium environment in deep-sea water.

To solve the above technical problems, a technical solution adopted by the present invention is: to provide a preparation method for a welded and extended super duplex stainless steel seamless pipe coil for a deep-sea umbilical cable, including the following steps: S1. adding alloying elements to an S32750 super ferritic/austenitic stainless steel base, controlling the composition of liquid steel through triple stripping pretreatment of hot metal and initial refining in an electric arc furnace to produce a qualified molten stainless steel; S2. in argon-oxygen refining in an AOD furnace, performing an oxidation reaction to raise the furnace temperature, adding ferrochrome to adjust the composition, adding ferrosilicon during a reduction period to remove CaO+MgO+Al₂O₃+SiO₂ slag from the steel, performing a decarbonization reaction to remove carbon to 0.03% or below so that the composition of liquid steel is stable; adding aluminum powder to the slag surface to perform deoxidation so that O element exists in the liquid steel in the form of Al₂O₃ inclusion; preparing high-alkalinity refining slag, and performing calcium treatment for optimization so that Al in the Al₂O₃ inclusion is replaced by Ca and enters the liquid steel without generating AlN, and the hard non-deforming Al2O3 inclusion is transformed into a plastic calcium aluminate inclusion with a low melting point, wherein the principle of calcium treatment is to generate 12CaO·7 Al₂O₃ as a liquid inclusion, without the formation of solid CaS inclusion; S3. in LF external refining, performing slight argon stirring, adding the high-content MgO+Al₂O₃ slag and performing deoxidation with aluminum powder to form a high-alkalinity atmosphere in the furnace, and then further adsorbing inclusions in the liquid steel, and finally casting an ingot by using the liquid steel, wherein the ferrite content in the ingot is controlled to be 45%-56%; S4. heating the ingot first, and then performing longitudinal compression on a high-speed forging press followed by transverse compression, so that the ingot is longitudinally compressed with a compression deformation ratio of at least 1; after the ingot is forged at least twice on the high-speed forging press, rolling the ingot on a bar hot rolling mill to finally obtain a round billet, wherein the total forging deformation ratio is at least 3.5, the longitudinal drawing deformation ratio is 3.5-5.5, and the total transverse deformation ratio/total longitudinal deformation ratio is 0.30-0.50, and the aspect ratio of the austenitic phase is controlled to be 1.0-3.0; S5. drilling positioning holes at the center of the round billet, wherein the piercing deformation temperature is 1080° C.-1200° C., the piercing deformation weakens the strain distribution effect and increases the dislocation density in the austenitic phase, the piercing rate of super duplex stainless steel can be increased to promote dynamic recrystallization; after piercing, the billet is rapidly cooled with water so that the volume fraction of detrimental σ phase in steel is controlled to be at most 0.2%; S6. performing cold-deformation plastic processing and solution heat treatment on the cold rolled pipe, wherein the total deformation of multiple passes is at least 80%, the temperature of solution heat treatment is controlled to be 1080±10° C., the two-phase ratio is accurately controlled to be 1:1, wherein the ferrite content is controlled to be 49-52%, and the detrimental σ phase in the steel is eliminated; and S7. performing a self-fusion welding and cosmetic circumferential girth welding process, wherein the outside of the pipe is protected by a high-purity argon-nitrogen mixture (Ar: 98% and N₂: 2%), and the inside of the pipe is protected by pure N₂; and carrying out polishing and testing, thus obtaining a welded and extended super duplex stainless steel seamless pipe coil.

In a preferred embodiment of the present invention, in step S2, in the oxidation stage of AOD furnace smelting, oxidation reaction is performed by large-flow pure oxygen blowing to raise the temperature in the furnace, and the composition adjustment is performed by adding the ferrochrome and melting alloying elements; when the decarbonization is completed, ferrosilicon is added during the reduction period, and chromium in the slag is reduced into the liquid steel, so that the CaO+MgO+Al₂O₃+SiO₂ slag formed in the liquid steel is removed from the steel; then, the decarbonization reaction is performed, wherein the gas introduced into the furnace is nitrogen and oxygen, the flow ratio of nitrogen to oxygen is 3:1, the mass fraction of carbon is reduced to 2×10⁻⁴ or below, and the nitrogen is blown to remove carbon to 0.03% or below; O contained in the liquid steel mainly exists in the form of FeO, MnO, SiO₂, Al₂O₃ and other inclusions, deoxidation with aluminum pellets and deoxidation with aluminum powder added on the slag surface are performed to form Al₂O₃ inclusion in the liquid steel, thereby greatly increasing the quantity of Al₂O₃inclusion in the liquid steel; to ensure the high alkalinity in the refining slag, the composition of the refining slag is adjusted to be: Cao 55%-70%, SiO₂ 10%-20%, and Al₂O₃15%-20%.

In a preferred embodiment of the present invention, in step S3, in the LF external refining process, slight argon stirring is performed, high-content MgO+Al₂O₃ slag is added and deoxidized with aluminum powder to form inclusions with high alkalinity, deep desulfurization is then performed to further adsorb inclusions in the liquid steel; the argon stirring in the furnace drives the circulation of liquid steel to produce bubbles to remove small-size inclusions; the size of inclusions in the liquid steel is controlled to be 15 μm or below and the quantity of inclusions is significantly reduced; the composition of inclusions is also changed from complex inclusions to pure Mg—Al spinel inclusions, and the inclusions become fine and dispersed; as the time of slight argon stirring increases, the O content in steel gradually decreases; after the time of argon stirring reaches 15 min, the O content decreases slowly due to the slight argon stirring; the time of slight argon stirring is controlled to be 17-23 min, so that the Al content in the steel is controlled to be at most 0.03% and the oxygen content is controlled to be at most 25 ppm.

In a preferred embodiment of the present invention, in step S4, after the initial forging, the ingot is reheated in a natural gas chamber furnace, wherein the temperature-rise temperature is 1130±20° C., the heating time is controlled to be 270±30 min, the temperature is controlled to be 1080° C.-1120° C., and the holding time is controlled to be 30-50 min; the ingot forged twice is reheated in a hot rolling heating furnace, wherein the heating time is controlled to be 200±20 min, the heating temperature is controlled to be 1050° C.-1100° C., and the holding time is controlled to be 15-25 min; the ingot undergoes longitudinal compression deformation on a bar mill with a compression deformation ratio of at least 1.5, and then rapidly cooled with water to room temperature, thus obtaining a steel bar.

In a preferred embodiment of the present invention, in step S5, when the temperature of the heating stage of an inclined-bottom heating furnace is less than 800° C., the round tube blank is heated slowly; the temperature distribution along the cross section and length direction of the tube blank is more uniform by extending the heating time and increasing the turning frequency of the round steel blank; in the high-temperature heating stage, the required temperature is reached by rapid heating.

In a preferred embodiment of the present invention, in step S6, the temperature of solution heat treatment is at most 1100° C.; the deformation of cold rolling pass is at most 16-40%, softening is performed by the pony-roughing multi-pass cold rolling process and the intermediate solution heat treatment temperature to obtain a large amount of deformation, the temperature of heat treatment process is controlled to be 1100±10° C., and the holding time is controlled to be 10-25 min; the solution heat treatment temperature of the finished product is controlled to be 1080±10° C., and the holding time is controlled to be 9-22 min; the preheating and temperature rise of 320-955° C. is achieved by improving the heat cycle of a furnace temperature field, and the heating rate is controlled to be 2-2.5° C./s, thereby reducing the quantity of σ and Cr₂N phase precipitated in the steel.

In a preferred embodiment of the present invention, in step S6, for the pony-roughing pass cold-rolled pipe, The deformation of cold rolling passes corresponding to the rolling deformation is at most 35-40%, the diameter reduction is controlled to be 29%-45%, and the wall reduction is controlled to be 26%-48%; the corresponding deformation of the cold rolling pass for rolling deformation corresponding to the deformation extension of the finished cold-rolled pipe is at most 16-30%, the diameter reduction is controlled to be 10%-42%, and the wall reduction is controlled to be 10%-46%.

In a preferred embodiment of the present invention, with the help of an oxygen analyzer, the welding process is implemented when the O content is at most 500*10-6; the proportions of peak value and base value are 200 ms and 300 ms, respectively, and the heat input is controlled to be 0.25-1.35 kJ/min.

In a preferred embodiment of the present invention, after welding, the residual height of the weld and the place where the unclear echo is generated are polished, wherein the width of the polished area is at most 20 mm-40 mm; a belt-sanding planetary system performs 360° accurate polishing on the surface of the weld of the pipe, and the linear speed of a polishing belt is 8-25 m/s.

In a preferred embodiment of the present invention, the composition of the welded and extended super duplex stainless steel seamless pipe coil comprises, in mass %: C: ≤0.030%, Mn: ≤1.00%, Si: ≤0.75%, P: ≤0.025%, S: ≤0.003%, Ni: 6.0-8.0%, Cr: 24.0-26.0%, Mo: 3.5-4.5%, N: 0.26-0.31%, W: ≤0.03%, Co: ≤0.06%, Nb: ≤0.03%, Ti: ≤0.10%, Al: ≤0.03%, Ce: ≤0.03%, B: ≤0.003%, O: ≤25 ppm; and impurity composition comprises, in mass %: Sb: ≤0.005%, Sn: ≤0.005%, and As: ≤0.01%;
the equivalent formula for the ferrite forming element Cr of the welded and extended super duplex stainless steel seamless pipe coil is expressed as Creq-Cr %+0.9*Mo %+1.5*Si %+0.5*Nb %+1.0*Ti %+2.5*A1%+0.5*W %, and the equivalent formula for the austenite forming element Ni is expressed as Nieq=Ni %+1*Co %+14.7*N %+30*C %+0.5*Mn %+0.3×Cu %.

The beneficial effects of the present invention are as follows: In the preparation method for a welded and extended super duplex stainless steel seamless pipe coil for a deep-sea umbilical cable, key metal composition control and strict control of oxygen and hydrogen elements that affect performance indexes, high-compression ratio forging technology, and a large-deformation cold-rolled pipe and solution heat treatment technology are adopted. In accordance with the ASTM A789/A789M standard for general-purpose seamless and welded ferritic/austenitic stainless steel pipes, key indexes of SAF2507 key mechanical properties are required as follows: tensile strength ≥800 Mpa, yield strength ≥550 MPa, elongation after fracture ≤25%, HRC: 22-32; the super duplex stainless steel for umbilical cables is required to have tensile strength of 850-1000 Mpa, yield strength of at least 700 MPa, elongation of at least 25%, HRC of 22-32; pitting resistance equivalent number (PREN) is increased from 41-45 to at least 42.5; pitting corrosion: ≤1.0 g/m² (according to ASTM G48, exposure at 50° C. for 24 hours, 10× magnification, no visual pitting found); the misalignment of two end faces of the tube-tube joint is at most 10% and is controlled at +0.2 mm. Thus, the requirement for long-term use of deep-sea umbilical cables with high reliability is met.

### BRIEF DESCRIPTION OF THE SEVERAL VIEWS OF THE DRAWINGS

In order to more clearly illustrate the technical solutions of the embodiments of the present invention, the following is a brief introduction to the drawings required for the description of the embodiments. Obviously, the drawings described below are only some embodiments of the present invention. For those of ordinary skill in the art, other drawings can be obtained based on these drawings without creative labor.

FIG. 1 is a SEM image of the surface of a sample after pitting test in Embodiment 1;

FIG. 2 is a SEM image of the surface of a sample after electrolysis test after polishing in Embodiment 1;

FIG. 3 is a SEM image of the surface of a sample after pitting test in Embodiment 2;

FIG. 4 is a SEM image of the surface of a sample after electrolysis test after polishing in Embodiment 2;

FIG. 5 is a SEM image of the surface of a sample after pitting test in Embodiment 3;

FIG. 6 is a SEM image of the surface of a sample after electrolysis test after polishing in Embodiment 3.

### DETAILED DESCRIPTION OF THE INVENTION

The technical solutions in embodiments of the invention are described clearly and completely below. The structure, proportion, size, etc. shown in the drawings of the specification are only for the purpose of understanding and reading the contents disclosed in the specification, and are not for the purpose of limiting the conditions that the invention can be implemented, so they have no technical significance, any modification of the structure, change of the proportional relationship or adjustment of the size shall still fall within the scope of the technical content disclosed by the invention without affecting the efficacy and purpose that can be achieved by the invention. Moreover, the terms such as “top”, “bottom”, “left”, “right”, “middle” and so on cited in the specification are only for the convenience of the description and not for limiting the scope of implementation, and the change or adjustment of the relative relationship shall also be regarded as falling within the scope of implementation of the invention without the material change of the technical content.

The content of C, Ni, Cr and Cu, in percentage by mass, in the composition of the welded and extended super duplex stainless steel seamless pipe coil for a deep-sea umbilical cable remains unchanged, ensuring the basic characteristics of super austenitic/ferritic duplex stainless steel. In view of the correlation between the PREN (Pitting Resistance Equivalent Number) and the content of alloying elements Cr, Mo and N, according to the equation: PREN=% Cr+3.3*% Mo+16*% N, from the aspects of content control and matching of alloying element Mo and N, the content of Mo and N in percentage by mass percentage is controlled at the upper limit deviation, so as to ensure that 42.5≤PREN≤45. In this way, the pitting resistance of S32750 super duplex stainless steel is obviously improved, especially the control accuracy for the content of the alloying element N is improved, so that the mechanical properties, fatigue and fracture toughness can meet the technical requirements.

The ductility and toughness of the body-centered cubic ferrite phase of the super duplex stainless steel which is body-centered cubic at room temperature are lower than those of the face-centered cubic austenite phase. As the ferrite content increases, the impact toughness decreases. Therefore, adjusting the α/γ two-phase ratio is the main means to improve the impact toughness. In order to achieve the strength and toughness of super duplex stainless steel, the two-phase equilibrium state (α/γ=1:1) is adopted, so that the super duplex stainless steel has a network-like or approximately network-like ductile austenite structure which plays a good hindering effect on cracks in the impact crack expansion process, thereby improving the overall mechanical properties and matching different chemical components and temperature combinations. Based on the thermodynamic property diagram of S32750 super duplex stainless steel, the corresponding data about the contents of α and γ phases and the change rule of α/γ ratio in the temperature range of solution heat treatment from 1050° C. to 1150° C. are obtained. In view of this, within a temperature range from 1060° C. to 1110° C., the equivalent correction formula for the ferrite forming element Cr of S32750 steel is expressed as Creq-Cr %+0.9*Mo %+1.5*Si %+0.5*Nb %+1.0*Ti %+2.5*A1%+0.5*W %, and the equivalent correction formula for the austenite forming element Ni is expressed as Nieq=Ni %+1*Co %+14.7*N %+30*C %+0.5*Mn %+0.3*Cu %. The accuracy of microstructure prediction of duplex stainless steel is improved, and the ferrite content of S32750 super duplex stainless steel is controlled to be within a range of 48% to 52%.

In electrochemical corrosion, the presence of oxides of Mn and Si will deteriorate the corrosive environment around them. As a result, the corrosion of the super duplex stainless steel increases, the pitting potential decreases, and the pitting resistance decreases. Thus, they promote the formation of pits and reduce the pitting resistance of the super duplex stainless steel. In addition, Si is an important element in the formation of G phase and σ phase and may cause weakening of the grain boundary. Therefore, the corrosion dissolution of a large quantity of oxides of Mn and Si is one of the main reasons for reducing the pitting resistance of super duplex stainless steel.

According to an element design solution for improving the strength and toughness, Nb, Ti, Co, W and Al elements are added in the traditional α+γ Cr—Ni super duplex stainless steel in combinations of NB—Ti and W—co—Al. These elements are dispersed and precipitated in the steel to form the fine and dispersed Nb, Ti (N, C) precipitated phase with multi-component complex structure and the Mo (W, Co, Al)—C—N compound strengthening phase, thereby inhibiting the growth of M₂₃C₆ phase size. In this way, the yield strength and impact toughness of steel at room temperature are improved. Cu atoms are precipitated in the form of copium-rich steel after high-temperature aging, which strengthens dispersion. Moreover, Cu has an antibacterial effect in the deep sea, which better inhibits the corrosion of deep-sea microorganisms to steel.

Trace B element is added. As an interstitial element, B enters the α+γ Cr—Ni super biphase stainless steel and interacts with C and N elements to form C—N—B compounds. After aging, B atoms enter the M₂₃C₆ phase near the grain boundary and inhibits the growth of M₂₃C₆ phase. And the B atoms are preferentially distributed along the original two-phase grain boundary, thus inhibiting the diffusion process along the grain boundary and strengthening the grain boundary. In this way, the strength and ductility indexes of tensile strength, yield strength, elongation after fracture and section shrinkage are significantly improved.

Ce element is added. As a rare earth element, Ce forms spherical composite inclusions containing Ce, Al and O during smelting, the Al₂O₃ content in the steel is reduced, the inclusions are modified obviously, and the detrimental influence of Al₂O₃ inclusion which cuts the matrix apart is reduced during impact deformation. The inclusion modification improves the impact performance and section shrinkage of SAF2507 super duplex stainless steel. Also thanks to the grain boundary strengthening and micro-alloying effects of the Ce element, fine granular rare earth oxides can be evenly and dispersively distributed in interfaces and defects. And a small amount of solid solution Ce plays a solid solution strengthening role, so that cracks hardly expand at the grain boundaries, cracks are forced to have transgranular fracture to consume more energy, and the impact toughness of the material is thus further improved.

O is a detrimental element in steel and mainly exists in the form of inclusions such as FeO, MnO, SiO₂, Al₂O₃, causing the reduction in the strength and ductility of steel. In particular, O has a serious impact on fatigue strength and impact toughness. Mainly by optimizing the refining slag, the type and shape of inclusions are improved and the size of inclusions is reduced.

By controlling the percentage of C element and adding rare earth element, S32750 super duplex stainless steel is purified and has excellent mechanical properties and pitting corrosion resistance, as well as excellent welding performance.

The welded and extended super duplex stainless steel seamless pipe coil for a deep-sea umbilical cable can meet the use standard of deep-sea umbilical cables and has high strength and toughness, corrosion resistance and durability. In accordance with the ASTM A789/A789M standard specification for general-purpose seamless and welded ferritic/austenitic stainless steel pipe, key indexes of SAF2507 key mechanical properties are required as follows: tensile strength ≥800 Mpa, yield strength ≥550 MPa, elongation after fracture ≤25%, HRC: 22-32. On this basis, it is required to improve the key mechanical and pitting resistance indexes of the super duplex stainless steel for umbilical cables so that tensile strength can reach 850-1000 Mpa, yield strength ≤700 MPa, elongation ≥25%, HRC: 22-32; pitting resistance equivalent number (PREN) is increased from 41-45 to 42.5-45; pitting corrosion: ≤1.0 g/m² (according to ASTM G48, exposure at 50° C. for 24 hours, 10× magnification, no visual pitting found); the misalignment of two end faces of the tube-tube joint is at most 10% and is controlled at +0.2 mm. Thus, the requirement for long-term use of deep-sea umbilical cables with high reliability is met.

In S32750 super austenitic duplex stainless steel, the inherent yield strength is high, two-phase ratio control, multiple indexes associated with low-temperature toughness and pitting corrosion resistance are controlled collaboratively. Firstly, based on the precise design of key elements, the relationship between strength, toughness, corrosion resistance and alloy composition is established. Secondly, the relationship between phase size reduction, high purity of deoxidation and dehydrogenation and high-performance preparation of rolling and heat treatment is clarified, a thermodynamic calculation model is used to calculate the relationship between different components and comprehensive properties, and the relationship between alloy composition and strength, toughness, yield ratio and point corrosion resistance is established, thereby providing theoretical basis for the design of key alloying elements for comprehensive properties. Based on the S32750 super duplex stainless steel, the precise control technology of N and Mo metal components is adopted to meet the performance requirements.

By adding metal elements Nb, Ti, Co, W, B, Ce to form a multi-component strengthening phase, the tensile and impact toughness and pitting resistance are improved. Moreover, the O content which affects impact toughness is controlled and the low-oxygen and high-purity stainless steel smelting process and high forging rolling reduction are adopted, thereby significantly improving the strength and toughness of steel. Suitable cold working rolling and solution heat treatment processes are adopted to ensure the two-phase ratio and pitting resistance, thereby further improving strength and toughness. Through metal composition optimization, high purity smelting, cold processing and high quality preparation, the comprehensive properties of steel are significantly improved, so as to meet the high index requirements of deep-sea umbilical cables.

C: ≤0.03%. C is an interstitial element and also an element which strongly expands an austenitic region. In the super austenitic/ferritic steel, C interacts with Cr, Mo, Ni, Nb, Ti, Co, W, Ce, Mn and Fe to form carbides. In S32750 super austenitic/ferritic steel, C interacts with N and B to form a coherent boundary with the matrix relative to M₂₃C₆ multi-component carbides, thereby achieving a strengthening effect. Therefore, by increasing the C content in austenitic stainless steel, the solid solution strengthening can significantly improve the mechanical properties of steel at room temperature, form and stabilize austenite and expand the γ phase region to meet the requirements of strength, impact toughness, pitting resistance and fatigue strength. Because the fluctuation range of the C content has a great influence on the two-phase ratio and too much carbon will also lead to the precipitation of a large number of carbides, embrittlement will occur in the steel during long-term service. Moreover, the ultra-low C content is more conducive to B's strengthening role in steel. Therefore, the C content is set to be at most 0.03%.

Si: ≤0.75%. Si is a strong ferrite forming element and its chromium equivalent is 1.5. It can improve the elastic limit, yield strength and yield ratio of super duplex stainless steel, and also improve the fatigue strength and fatigue ratio. However, in super duplex stainless steel, Si is an important element to form detrimental G phase and σ phase and will cause grain boundary weakening. Moreover, in the deep-sea corrosive environment, the pitting potential is reduced, and the pitting resistance is decreased. Based on the influence of Si content on S32750 super duplex stainless steel, the Si content is reduced by 0.05%. Therefore, the Si content in the super duplex steel is set to be at most 0.75%.

Mn: ≤1.00%. Mn is an element for expanding and stabilizing austenite and its nickel equivalent is 0.5. The addition of Mn in super austenitic/ferritic stainless steel will promote the precipitation of oxide inclusions of Mn, Si, Cr, Al in the steel. These inclusions are easily corroded by the solution containing Cl ions and also promote the formation of pits as the starting point of pitting. With the increase of Mn content, the total amount of inclusions in steel increases significantly, the corrosion rate increases, and the pitting potential decreases, the formation of pits is promoted and the pitting resistance of super austenitic/ferritic duplex stainless steel is reduced. Based on the influence of Mn content on SAF2507 super duplex stainless steel, the Mn content is reduced by 0.2%. Therefore, the Mn content is set to be at most 1.0%.

Cr: 24.0-26.0%. Cr is a typical ferrite forming element and also an essential element for improving corrosion resistance in super duplex stainless steel. Cr which is solid soluble in Fe matrix is a main element to form the M₂₃C₆ phase. It increases the electrode potential of the matrix and improves the corrosion resistance of the steel. However, Cr is a ferritic element and can forms a continuous solid solution with Fe, reducing the austenitic phase region. Moreover, Cr can easily forms a Cr₂N detrimental phase with N element in super duplex stainless steel. Therefore, the Cr content is set in a range of 24.0-26.0%, which can ensure the corrosion resistance of the steel.

Ni: 6.0-8.0%. Ni is an element that strongly forms and stabilizes austenite and expands the austenitic phase region and it can improve the potential and purification tendency of austenitic stainless steel. In order to control the ferritic/austenite two-phase ratio in steel, the Ni content in steel is generally controlled at about 7%. Meanwhile, Ni can inhibit the formation of σ phase. The Ni content is set in a range of 6.0-8.0%.

Mo: 3.5-4.5%. Mo is a refractory metal and also a stable ferritic element and belongs to the strong carbide forming element. Ni can prevent the damage of Cl— to a passivation film and the pitting tendency caused by the presence of chloride ions and also can improve the pitting resistance in super duplex stainless steel. Mo can reduce the solubility of C in austenitic stainless steel, accelerate the formation of Cr₂₃C₆, improve the mechanical properties of steel, and reduce the upper and lower limit deviations of Mo content. Therefore, the Mo content is set in the range of 3.5-4.5%.

P≤0.025%, S≤0.003%. P and S are unavoidable impurity elements in the stainless steel smelting process. the increase of P and S elements will cause ductility and impact toughness (i.e., cold shortness and hot shortness) to be significantly reduced, and has an adverse effect on the performance of super duplex stainless steel. The contents of P and S should be controlled at lower values. The upper limit deviations of P content and S content are adjusted to S≤0.003% and P≤0.025% respectively from P≤0.035% and S≤0.020%.

N: 0.26-0.31%. Nis an element that expands the austenitic phase region of steel and an element that strongly forms and stabilizes austenite. Like C element, N element is solid soluble in Fe, forming an interstitial solid solution. In steel, the N element can play a solid solution strengthening role, reduce stacking fault energy, increase the stability of super duplex stainless steel structure, inhibit carbide precipitation and delay σ (x) phase precipitation. The addition of N element in ultra-low carbon steel in super duplex stainless steel increases the strength and hardness of steel without causing significant reduction of ductility. Moreover, the N element improves the strength of steel, and also optimizes the resistance of steel to intergranular corrosion and stress corrosion. Therefore, the N content is set at the upper and lower limit deviations of S32750 super duplex stainless steel. The N content is set in the range of 0.26-0.31%.

B: ≤0.003%. As an interstitial element, B in steel interacts with Mo, Ni, Nb, Ti, Co, W, Ce and other elements to form multi-component B—C—N compounds. B atoms can enter the M₂₃C₆ phase near the grain boundary, thereby improving the tensile strength and also improving the section shrinkage and elongation and other ductility indexes. B can significantly stabilize carbides and inhibit the recovery process. There is a large difference in the size of B and Fe atoms, and B atoms have strong elastic bonding with dislocation and grain boundaries and can easily form equilibrium segregation on the grain boundaries, reducing the precipitation rate and quantity of Cr₂₃C₆ phase at the crystal valence. Moreover, B atoms make Cr₂₃C₆ phase small and stable in the crystal, thereby improving mechanical properties and pitting resistance. Therefore, the B content is set to be at most 0.003%.

W: ≤0.03%. W is a typical solid solution strengthening element, an element that reduces the austenitic phase region, and also a strong carbide forming element, which is partially dissolved into steel to form a solid solution. W can improve the corrosion resistance and mechanical properties of steel in deep-sea corrosive environment. However, too much W will lead to the increase of 8 ferrite content. Moreover, super duplex stainless steel with too much W leads to low high-temperature ductility, high deformation resistance, and poor hot workability. Therefore, the W content is set to be at most 0.03%.

Co: ≤0.06%. Co in super duplex stainless steel can inhibit the formation of δ ferrite. The Co element plays a solid solution strengthening role in steel, is soluble in the matrix. Appropriate addition of Co element can improve the ductility and hot workability of steel. Therefore, the Co content is set to be at most 0.06%.

Nb: ≤0.03%. Nb is a strong carbide forming element and combines with C, N, B in S32750 super duplex stainless steel to form multi-component compounds, thereby playing a solid solution strengthening role. Nb can increase the strength of steel without affecting the ductility or toughness of the steel. Due to the effect of reducing the two-phase grain size, Nb can improve the impact toughness of steel and reduce the brittle transition temperature of the steel. When its content is more than 8 times that of carbon, almost all the carbon in the steel can be immobilized, so that the steel has good H₂ resistance. The Nb element in S32750 super duplex stainless steel can improve the strength and corrosion resistance. Therefore, the Nb content is set to be at most 0.03%.

Ti: ≤0.01%. Ti is a stable forming element for the formation of compounds of C and N, and is a good deoxidation degassing agent and an effective element for immobilizing nitrogen and carbon. Although Ti is a strong carbide forming element, it does not combine with other elements to form complex compounds. Titanium carbide with strong binding force is stable and hardly decomposes. When dissolved into the solid solution at high temperature, the titanium carbide plays a solid solution strengthening role, improves the strength, the ductility and impact toughness, and intergranular corrosion resistance of the steel. The Ti element inhibits the tendency of grain growth during welding and improves the weldability of steel. Therefore, the Ti content is set to be at most 0.01%.

Al: ≤0.03%. Al is added to steel as a deoxidizer or alloying element. Al has stronger deoxidation capacity than Si and Mn. The Al element, together with Ce element, is used as the main means to reduce O content in the steel smelting. In SAF super duplex stainless steel, Mo, Cu, Cr, Nb, Ti, Ce, W, Co, etc. work together to thin the grain in the steel and immobilize N in the steel, thus significantly improving the strength, impact toughness, corrosion resistance of the steel, and reducing the tendency of low-temperature cold shortness. Too much Al will affect the hot workability, weldability and machinability of steel. Therefore, the Al content is set to be at most 0.03%.

Ce: ≤0.03%. Ce is added to steel to play a role of deoxidation, desulfurization and micro-alloying to improve the deformation ability of inclusions. Trace Ce solution in the matrix can purify grain boundaries, denature inclusions, homogenize structure, reduce precipitation and segregation at the grain boundaries, thereby improving the corrosion resistance and mechanical properties of steel. Especially, Ce denatures the brittle Al₂O₃ to a certain extent, thereby improving the fatigue performance of steel. The Ce element plays a role of grain boundary strengthening and micro-alloying. Fine granular rare earth oxides can be evenly and dispersively distributed in interfaces and defects. And a small amount of solid solution Ce plays a solid solution strengthening role, so that cracks hardly expand at the grain boundaries, cracks are forced to have transgranular fracture to consume more energy, and the impact performance of the material is thus further improved. The Ce element can also improve the oxidation resistance and corrosion resistance of the steel. Ce can improve the fluidity of steel, reduce non-metallic inclusions to obtain a dense and pure steel structure. It plays the role of cleaning technology and alloying. Therefore, the Ce content is set to be at most 0.03%.

O: ≤25 ppm. O is a detrimental element in steel. The influence of the O element on the properties of steel is mainly related to the composition, nature, distribution and quantity of oxidized inclusions. All the inclusions reduce the ductility, impact toughness and fatigue strength of steel to varying degrees. Especially when the steel is in service under long life conditions, the O element should be controlled as a detrimental element. Therefore, at the end of steelmaking, Mn, Si, Al, Ce are added for deoxidation, especially during the solidification of liquid steel, the reaction of O and C in the solution will generate CO bubbles to remove O. Therefore, the O content is set to be at most 25 ppm.

As: ≤0.01%. As is a low-melting point element, often exists in the form of Fe₂As, Fe₃As₂, FeAs and solid solution in steel, and has a serious tendency to segregation. When the content of As reaches 0.2%, it will increase the shortness of steel and reduce the ductility. Therefore, the As content is set to be at most 0.10%, preferably at most 0.01%

Sb: ≤0.005%. Sb is an element that reduces the austenitic phase region, can combines with Fe to form a low-melting point compound, and has a serious tendency to segregation. Sb element must be strictly controlled. Therefore, the Sb content is set to be at most 0.005%.

Sn: ≤0.005%. Sn is a low-melting point element which greatly reduces the high-temperature mechanical properties of austenitic stainless steel, and is also detrimental to the hot workability. The mass fraction of Sn in austenitic stainless steel should not be higher than 0.01%. Therefore, the Sn content is set to be at most 0.005%.

Based on the metal composition of the material, the structure and performance are determined. Based on the original composition of S32750 super austenitic/ferritic duplex stainless steel, the detrimental elements P and S in the steel composition are controlled, and the mass percentage contents of Cr, Mo and N, which affect the pitting index, is set to be close to upper limits to improve the pitting resistance. Moreover, W, Co, Nb, Ti, Al, Ce, B and other multiple alloying elements are added to the steel to improve the strength and toughness, pitting resistance and excellent weldability of the steel through modification. The mass percentage content of O in steel is controlled strictly to ensure the impact toughness of steel. The contents of Sb, Sn, As, P, S, which easily cause excessive inclusions in steel, are controlled strictly so as to reduce the harm of inclusions to the steel. The composition, by mass %, comprises: C: ≤0.030%, Mn: ≤1.00%, Si: ≤0.75%, P: ≤0.025%, S: ≤0.003%, Ni: 6.0-8.0%, Cr: 24.0-26.0%, Mo: 3.5-4.5%, N: 0.26-0.31%, W: ≤0.03%, Co: ≤0.06%, Nb: ≤0.03%, Ti: ≤0.10%, Al: ≤0.03%, Ce: ≤0.03%, B: ≤0.003%, O: ≤25 ppm. Sb: ≤0.005%. The detrimental elements are strictly controlled, and the impurity composition, by mass %, comprises: Sb: ≤0.005%, Sn: ≤0.005%, As: ≤0.01%.

By using a thermodynamic calculation model, the two-phase ratio and pitting resistance index of S32750 super austenitic/ferritic stainless steel are co-designed. The overall pitting resistance of super duplex stainless steel is improved mainly by improving the pitting resistance index PREN of steel and the equilibrium design and control of the ferritic/austenitic two-phase ratio. 1) According to the pitting resistance index: PREN=% Cr+3.3*% Mo+16*% N, Cr and Mo which are enriched in the ferritic phase in super duplex steel and N which is solid soluble in super duplex stainless steel are the key elements influencing the pitting resistance and PREN of duplex stainless steel. The mass percentage contents of Mo and N are controlled in the upper and lower limit deviations, that is, Mo: 3.5-4.5%, N: 0.26-0.31%, to ensure that 42.5≤PREN ≤45, thereby significantly improving the pitting resistance of S32750 super duplex stainless steel. 2) The main alloying elements Cr, Mo, N and Ni in the steel have different distribution coefficients in the two phases, causing a PREN difference between the ferritic phase and the austenitic phase in the duplex stainless steel. The phase with poor corrosion resistance will be firstly corroded, so the actual pitting of steel depends on the effect of the phase with low PREN on the pitting resistance. With respect to the numerical changes of the PREN of the ferritic (BCC) γ phase and austenitic (FCC) α phase caused by the deviations adjustment of the composition of S32750 in the experimental temperature range of 1050° C.-1150° C. and the change rule of α/γ two-phase ratio, the equilibrium-state thermodynamic calculation and analysis show that with the increase of the Ni equivalent element, the PREN of the α phase gradually increases and the PREN of the γ phase gradually decreases. In this way, the two phases are kept in equilibrium. As a result, within a temperature range from 1060° C. to 1110° C., the equivalent correction formula for the ferrite forming element Cr of S32750 steel is as expressed Creq-Cr %+0.9*Mo %+1.5*Si %+0.5*Nb %+1.0*Ti %+2.5*A1%+0.5*W %, and the equivalent correction formula for the austenite forming element Ni is expressed as Nieq=Ni %+*Co %+14.7*N %+30*C %+0.5*Mn %+0.3*Cu %. The accuracy of microstructure prediction of duplex stainless steel is improved, and the ferrite content of S32750 super duplex stainless steel is controlled to be within a range of 47% to 51%. 3) In the steel, Cr, Mo and N coefficients are different. The Mo content has a greater impact on the PREN of the two phases, N has a more important role in the equilibrium adjustment of the PREN of the two phases in the super duplex stainless steel. As an interstitial atom, N is mainly solid soluble in the austenitic phase with large octahedral interstice and FCC structure, while its solid solubility is very small in the ferritic phase with small tetrahedral interstice and BCC structure. Therefore, with the increase of N content, the α value of PREN index changes little, and the γ value increases significantly. By adjusting the PREN index difference between the two phases through N, the two-phase structure with PREN equilibrium is obtained, thereby achieving the overall two-phase ratio and performance equilibrium and significantly improving the corrosion resistance and room-temperature strength. The content of N element in steel is 0.26-0.31%, which realizes the equilibrium design of two-phase ratio and corrosion resistance of steel.

In electrochemical corrosion, the presence of oxides of Mn and Si will deteriorate the corrosive environment around them. As a result, the corrosion of the super duplex stainless steel increases, the pitting potential decreases, and the pitting resistance decreases. Thus, they promote the formation of pits and reduce the pitting resistance of the super duplex stainless steel. In addition, Si is an important element in the formation of G phase and σ phase and may cause weakening of the grain boundary. Therefore, the corrosion dissolution of a large quantity of oxides of Mn and Si is one of the main reasons for reducing the pitting resistance of super duplex stainless steel. According to an element design solution for improving the strength and toughness, Nb, Ti, Co, W and Al elements are added in the traditional α+γ Cr—Ni super duplex stainless steel in combinations of NB—Ti and W—co—Al. These elements are dispersed and precipitated in the steel to form the fine and dispersed Nb, Ti (N, C) precipitated phase with multi-component complex structure and the Mo (W, Co, Al)—C—N compound strengthening phase, thereby inhibiting the growth of M₂₃C₆ phase size along the grain boundary and strengthening the grain boundary. Cu, B and Ce form nano-precipitated phases in steel, which play a role in reducing the sizes of the two phases. By the alloy design based on coupling of multiple trace elements, the tensile and yield strength, impact toughness at room temperature and corrosion resistance of steel are significantly improved.

Provided is a preparation method for a welded and extended super duplex stainless steel seamless pipe coil for a deep-sea umbilical cable, including: performing initial refining in an electric arc furnace and triple stripping pretreatment of hot metal, adjusting the amount of alloy materials added to control the composition of the liquid steel and adjusting the temperature of the liquid steel, wherein the alloy materials include ferrochrome, ferronickel, ferrosilicon, ferromolybdenum and ferromanganese which are used as raw materials. In this way, a qualified liquid stainless steel with a homogeneous composition is produced.

In the oxidation stage of AOD furnace smelting, oxidation reaction is performed by large-flow pure oxygen blowing to raise the temperature in the furnace, and the composition adjustment is performed by adding ferrochrome and melting alloying elements. When decarbonization is completed, ferrosilicon is added during the reduction period, mainly to deoxidize and chromium in the slag is reduced into the liquid steel. The CaO+MgO+Al₂O₃+SiO₂ slag formed in the steel is removed from the steel. Then decarbonization reaction is performed, where the carbon content continues to decrease, the temperature in the furnace continues to increase, the gas introduced is nitrogen and oxygen, the flow ratio of nitrogen to oxygen is 3:1, the mass fraction of carbon is reduced to 2*10-4 or below. In the reduction stage, the main reactions are deoxygenation partial pressure, desulfurization reaction and reaction for reducing Cr with Si. Nitrogen is blown to remove carbon to 0.03% or below, and the composition of liquid steel is basically stable. In this case, the O contained in the liquid steel mainly exists in the form of FeO, MnO, SiO₂, Al₂O₃ and other inclusions. In order to ensure the deoxygenation of steel, firstly, 3 or 5 mm (content ≥99.7%) deoxidation aluminum pellets with good deoxygenation effect is added. Secondly, deoxidation is implemented by adding aluminum powder to the slag surface to form Al₂O₃ inclusion in the liquid steel, thereby greatly increasing the quantity of Al₂O₃ inclusion in the liquid steel. Moreover, in order to improve the thermal processing and corrosion resistance, the refining slag needs to have high alkalinity. The composition of the refining slag is adjusted to be: CAO 55%-70%, SiO₂ 10%-20%, and Al₂O₃ 15%-20%, and floating inclusions are adsorbed, thereby significantly reducing the inclusions in steel to achieve the purpose of deoxidation. Then, through calcium treatment for optimization, Al in the Al₂O₃ inclusion is replaced by Ca and enters the liquid steel without generating AlN, thereby avoiding the problem that a significant decrease in the content of N in the steel causes a failure in controlling the two-phase ratio and improving the PREN. The hard non-deformed Al₂O₃ inclusion is transformed into a plastic calcium aluminate inclusion with a low melting point. The principle of calcium treatment is to generate 12CaO·7 Al₂O₃ as a liquid inclusion. By adjusting the length of the calcium line to 3.5±0.1 m, the formation of solid CaS inclusion can be avoided.

In the LF external refining process, slight argon stirring is performed, the high-content MgO+Al₂O₃ slag is added and deoxidized with aluminum powder to form inclusions with high alkalinity and low melting point, deep desulfurization is then performed to further adsorb inclusions in the liquid steel. Argon stirring in the furnace drives the circulation of liquid steel to produce bubbles to remove small-size inclusions. At the same time, the small-size inclusions collide with each other and aggregate to form large-size inclusions faster, and the inclusions float up quickly to be removed. The size of inclusions in the liquid steel is controlled to be 15 μm or below and the quantity of inclusions is significantly reduced. The composition of inclusions is also changed from complex inclusions to pure Mg—Al spinel inclusions, and the inclusions become fine and dispersed. As the time of slight argon stirring increases, the O content in steel gradually decreases. When the time of argon stirring reaches 15 min, the O content decreases slowly due to the slight argon stirring. The time of slight argon stirring is controlled to be 17-23 min, so that the Al content in the steel is controlled to be at most 0.03% and the oxygen content is controlled to be at most 25 ppm. The requirements of SAF2507 steel for ultra-low oxygen and fine and dispersed inclusions are achieved, and the purity, mechanical properties, fracture toughness and fatigue strength of the steel are significantly improved.

A low-oxygen high-purity refining technology is adopted. The inclusions are graded as follows: inclusion type A (thin)≤1.0, inclusion type A (thick)≤1.0, inclusion type B (thin)≤1.0, inclusion type B (thick)≤1.0, inclusion type C (thin)≤1.0, inclusion type C (thick) ≤1.0, inclusion type D (thin)≤1.0, inclusion type D (thick)≤1.0, and the total of the above five types ≤3.0; DS≤1.5. In this way, the mechanical properties of the pipe is improved.

The high-temperature ferrite in the ingot during the solidification process of liquid steel is reduced, so as to ensure the two-phase equilibrium of ferrite and austenite in super duplex stainless steel. The analysis on the precipitation behavior of the ferritic phase in the non-equilibrium solidification process of liquid steel and the high-temperature diffusion behavior of the ferritic phase in the solid state shows that at the surface of the ingot, cooling strength is large, the two-phase content is relatively balanced and the phase size is small, and the cooling strength of the ingot center is lower than the surface due to the restriction of heat transfer conditions, resulting in a high content of the ferritic phase and a large phase size. The casting system is protected by argon gas in advance. By optimizing the low superheat, low-temperature gradient and cooling technology of the casting, the phase ratio and phase size during the solidification process of the casting are reduced, and the macro-segregation and dendrite segregation are controlled. The ferrite content is controlled to be 45-56%, and the specification is 220 mm square ingot.

The technology of free ingot forging and continuous bar rolling is used. By the full-size temperature field-strain field coupling control in the ingot forging process, the total deformation ratio of forging is at least 3.5, the aspect ratio is effectively controlled to be 2.0-3.0 in the drawing process of the ferritic phase, thereby forming an S32750 super duplex stainless steel bar with high strength and toughness and small phase size.

The 220 mm square ingot is heated in a natural gas chamber furnace, where the heating speed is controlled to 2-2.5° C./min, the temperature-rise temperature is 1150±20° C., the heating time is 450±30 min, the temperature-holding heating temperature is controlled to 1110° C.-1150° C., and the holding time is controlled to 45-70 min. During the forging process, longitudinal compression is carried out on a high-speed forging press first, followed by transverse compression, so that the ingot undergoes longitudinal compression deformation with a compression deformation ratio (cross-sectional area before deformation/cross-sectional area after deformation) of ≥1, so as to eliminate dendrites, segregation and other defects in the steel to obtain the forged blank with uniform shape.

After the initial forging, the ingot is reheated in the natural gas chamber furnace, where the temperature-rise temperature is 1130±20° C., the heating time is controlled to be 270±30 min, the temperature is controlled to be 1080° C.-1120° C., and the holding time is controlled to be 30-50 min. The inner and outer temperatures of the forging along the cross section are consistent, thereby avoiding cracks and other defects caused by uneven section temperature from the outside to the core. The ingot undergoes further longitudinal compression deformation with a compression deformation ratio (cross-sectional area before deformation/cross-sectional area after deformation) of ≥1 on the high-speed forging press, and is then drawn and rounded longitudinally to obtain the forged round billet with uniform shape.

The ingot forged twice is reheated in the hot rolling heating furnace, the heating time is controlled to be 200±20 min, the heating temperature is controlled to be 1050° C.-1100° C., and the holding time is controlled to be 15-25 min. The ingot undergoes longitudinal compression deformation on a bar mill with a compression deformation ratio (cross-sectional area before deformation/cross-sectional area after deformation) of ≥1.5, and then rapidly cooled with water to room temperature. The ingot is rolled into φ65 mm, φ90 mm steel bars, with outer diameter tolerance of ±0.1 mm and ellipticity of ≤0.12 mm.

In order to improve the impact toughness of duplex stainless steel, the ingot is forged twice on the high-speed forging press and rolled on the bar mill, and the ingot is controlled to undergo different longitudinal thermoplastic deformations. The total hot forging deformation ratio of the final product is controlled to be at least 3.5, the total longitudinal drawing deformation ratio is 3.5-5.5, and the total transverse deformation ratio/total longitudinal deformation ratio is 0.30-0.50. In this way, the two-phase ratio of S32750 super duplex stainless steel is further reduced, so that the austenite in the steel forms a network/approximate network structure. By repeated forging, the grains are clustered together, the deformation of the steel induces phase change, the phase size of the two phases is reduced and drawn out, and the aspect ratio is controlled to be 1.0-3.0; through rapid cooling after cold rolling, the σ and Cr₂N detrimental phases of forging are eliminated, thereby further improving the strength and room-temperature impact toughness of the steel.

Technical simulation based on temperature-stress-strain multi-field coupling in hot piercing process. In the process of hot piercing, the interaction of multiple physical fields occurs inside the round billet during the transfer process from a solid state to a hollow state, which accurately simulates the process characteristic behavior under multi-coupling conditions during the hot piercing process, thus improving the hot workability of SAF2507 super duplex stainless steel.

In view of the high content of Cr, Mo and N in SAF2507 super two-phase steel, the ferritic and austenitic two-phase structures have different softening laws at high temperature, resulting in unbalanced stress and strain distribution, and cracks easily nucleate and expand at the phase boundary of steel. Therefore, the hot piercing process is affected by multiple factors such as strain rate, deformation temperature, and austenite and austenite shape. The high-temperature mechanical properties and thermoplasticity of ferrite and austenite in steel are quite different in hot piercing. The ferritic phase has good thermoplasticity within a wide temperature range, while austenite can only have good at a high temperature. The mismatch between the thermoplasticity ranges of the two phases makes hot piercing difficult. Through the thermoplastic process research at different temperatures and strain rates, the ferritic and austenitic two-phase structures in super duplex stainless steel have different hardness at a temperature of at least 1050° C. and also has different softening mechanisms in the thermoplastic deformation process. The ferritic phase in the steel can obtain a good dynamic thermoplastic softening in a wide temperature range. The austenitic phase in steel can only have good thermoplasticity at a high temperature. When the piercing deformation temperature reaches 1150° C.-1200° C., the piercing deformation rate weakens the strain distribution effect and increases the dislocation density in the austenitic phase. Therefore, the piercing rate of super duplex stainless steel can be increased to promot dynamic recrystallization. Moreover, the production efficiency and yield of S32750 super duplex stainless steel during hot piercing are improved.

The positioning holes are drilled in the center of φ65 mm and φ90 mm round billet to avoid the obvious temperature drop of round billet caused by the piercing process after hole drilling. After the central deformation region is repeatedly rolled to form a cavity, the inner surface cools too fast to cause rapid precipitation of σ phase, thereby forming cracks on the inner surface of the cavity due to stress.

With respect to the low thermal conductivity, low ductility and heating characteristics of circular continuous heating furnace in the heating process of S32750 super duplex stainless steel, when the temperature of the temperature rise stage of the inclined-bottom heating furnace is less than 800° C., the round billet is heated slowly. The temperature distribution along the cross section and length direction of the billet is more uniform by extending the heating temperature-rise time and increasing the turning frequency of the round steel blank. In the high-temperature heating stage, the required temperature is reached by rapid heating (in order to reduce the precipitation of detrimental σ in the steel), the temperature rise time of φ65 mm round billet is at most 1.9 h, and the temperature rise time of 490 mm round billet is at most 2.5 h. The round billet is fully insulated in the soaking stage, so that the internal and external temperatures of the round billet along the cross section of the pipe are consistent to ensure uniform heating of the round billet. In addition, the influence factors that the intense friction on the interface between the round billet and the head will increase the internal temperature during the hot piercing process is also considered.

Hot piercing with a narrow temperature window meets the requirement of S32750 super duplex stainless steel. By controlling the upper temperature limit, the formation of thick ferrite grains is prevented. The lower limit of temperature is controlled, and the distribution of uneven stress and strain in two phases is controlled. Moreover, the formation of M₂₃C₆, Cr₂N, σ phase, x phase and other brittle phases is prevented between the two phases. Therefore, for the φ65 mm round billet, heating temperature is 1080-1120° C., the time of temperature rise+high-temperature heating is controlled to be 150-160 min, the holding time for soaking is controlled to be 15-30 min. For the φ90 mm round billet, heating temperature is 1090-1130° C., the time of temperature rise+high-temperature heating is controlled to be 180-290 min, the holding time for soaking is controlled to be 20-40 min.

Combined with the increase and distribution characteristics of the stress strain field and temperature field of the skew rolling hot piercing with large milling angle and the temperature field in the process of the head piercing, the intense friction on the interface between the round billet and the head will form a cavity under the action of alternating shear stress and transverse tensile stress, and the internal temperature of the cavity will increase. Based on the deformation law of austenitic phase in super duplex steel, the technical parameters such as head elongation, roll spacing, guide spacing, head diameter, roll speed and head front rolling reduction in skew rolling piercing process are adjusted and optimized. For the φ65 mm round billet, the roll speed is controlled to be 86-93 rpm. For the φ90 mm round billet, the roll speed is controlled to be 75-80 rpm. The billet is then rapidly cooled in water, so that the detrimental σ phase in the steel is controlled to be at most 0.2%.

In the cold-rolled pipe+solution heat treatment cold deformation plastic processing of S32750 super two-phase stainless steel seamless pipe, the total deformation of multiple passes is at least 80%, the temperature of the solution heat treatment is controlled to be 1080±10° C. to eliminate the detrimental phase in the steel; the two-phase ratio is accurately adjusted to 1:1, thereby improving the mechanical properties and pitting resistance of steel.

Based on the maximum allowable stress for the formation of the S32750 super duplex stainless steel seamless pipe, the deformation amount of cold rolling and the matched rolling forming pass process of each specification are simulated and analyzed, where the core process is cold-rolled pipe processing+solution heat treatment, and the key technology is the integrated control of deformation amount and distribution in cold deformation plastic processing and the removal of the detrimental phase in heat treatment. Material physical metallurgy modeling based on the prediction and control of microstructure properties of cold-rolled super duplex steel pipes. According to the structure control law of recrystallization and precipitation process with drastic changes during seamless cold rolling of S32750 super dual-phase stainless steel, the deformation degree and deformation speed of the whole process of cold rolled pipe are controlled, and the deformation load distribution of multi-pass rolling is carried out in a rational, energy-saving and efficient manner. Considering the conditions for finished super duplex stainless steel pipe with no detrimental phase precipitation, two-phase equilibrated high-impact toughness, and high pitting resistance, according to different specifications and class interval requirements, the corresponding processing amount and process pass matching are formed. The accumulation of multi-pass rolling makes the grain size smaller and also meets the core index requirements of pitting.

The precipitation phase of S32750 stainless steel pipe has a high content of alloying elements Cr, N and Mo, and the precipitation of these alloying elements causes the decline of ductility and corrosion resistance. In the temperature rise range of 900-1020° C. for solution heat treatment, it is easy to produce detrimental ø secondary phase, which affects room-temperature and low-temperature impact toughness respectively. The σ phase precipitation that is the most detrimental to this product is at the phase boundary between austenite γ2 and ferrite a near the original grain boundary of ferrite. Nucleation of σ phase takes precedence over α/α and α/γ grain boundaries, and σ phase is block-like or flake-like and grows in the ferrite of steel, resulting in a sharp reduction in the strength and toughness of the pipe and an increase in hardness. At a temperature of 1020° C.-1100° C., the precipitation of σ phase gradually decreases with the increase of temperature. After solid solution treatment at 1080° C., the microstructure of the two phases is uniform without precipitation phase. When the temperature is higher than 1080° C., the quantity of austenitic phase decreases, and the proportion of ferrite phase increases. At a temperature of 1040° C.-1100° C., the phase proportion of S32750 changes little and basically achieves phase equilibrium, so the requirements of phase equilibrium can be met in this range. At a temperature of 1100° C.-1300° C., with the increase of ferrite content, a large amount of non-equilibrium nitride Cr₂N is generated in ferrite and a ferritic subgrain boundary, and the strength and hardness are correspondingly increased, while toughness is decreased.

The corrosion rate of S32750 decreases first and then increases as the temperature of solution heat treatment increases between 900° C. and 1300° C. The temperature range of solution heat treatment can improve the pitting resistance. When the temperature of solution heat treatment is at most 1000° C., the precipitation of chrome-rich σ phase reduces the content of chromium in the matrix, and the corrosion resistance decreases. When the temperature of solution heat treatment is at least 1100° C., too high ferrite content will reduce the content level of Cr, Mo, N elements in the ferritic phase, resulting in disequilibrium in PREN between the ferritic phase and the austenitic phase. The phase at a low level will be corroded first, resulting in a decrease in overall corrosion resistance of the S32750 super duplex stainless steel seamless pipe. Therefore, the pitting rate can be reduced to the lowest value when the temperature of solution heat treatment is 1060-1100° C.

S32750 super duplex stainless steel seamless pipe-high-temperature intermediate annealing heat treatment-reasonable distribution of deformation” integrated cold deformation control: the temperature of solution heat treatment is at most 1100° C.; the deformation of cold rolling pass is at most 16-40%. Softening is performed by the pony-roughing multi-pass cold rolling process and the intermediate solution heat treatment temperature to obtain a large amount of deformation, thereby ensuring no precipitated phase and no significant phase size growth. Preparation for subsequent cold-rolled pipe processing The temperature of the heat treatment process is controlled to be 1100±10° C., and the holding time is controlled to be 10-25 min. The cold rolling process of finished pipe can meet the requirement for controlling the phase size by properly reducing the cold rolling deformation+solution heat treatment temperature of finished product, so as to improve the key indexes of tensile strength, impact work at room temperature and pitting performance. The temperature of solution heat treatment should be properly high. The solution heat treatment of the finished pipe should be carried out at the similar proportion of the two phases, and the solution heat treatment temperature of the finished product should be controlled to be 1080±10° C., and the holding time should be controlled to be 9-22 min. The requirements for strength, toughness and pitting performance are met.

A tunnel continuous roll-bottom solution heat treatment furnace is adopted to establish a reasonable solution heat treatment system with uniform temperature and rapid cooling that matches the performance improvement. The preheating and temperature rise of 320-955° C. is achieved by improving the heat cycle of the furnace temperature field, and the heating rate is controlled to be 2-2.5° C./s to reduce the quantity of σ and Cr₂N phase precipitated in the steel. Sufficient solution heat treatment time in the soaking stage ensures a sufficient pipe structure and a reasonable phase content. The rapid cooling system is adopted, and the rapid cooling rate can be adjusted to 35-90° C./s, so that the cooling rate can be controlled, and the fine and homogeneous two-phase structure can be precipitated, and the strength and toughness of the material and the pitting resistance can be improved.

By increasing N content and coupled addition of multiple trace elements such as Nb, Ti, Co, W and Ce, the two phases of N-alloyed super duplex stainless steel with Cr, Mo and Ni content in steel are composed of austenitic phase rich in Ni, C, N and Co and Ni-containing ferritic phase rich in Cr, Mo, W, Ti and Nb with ultra-low C and N. This characteristic of phase composition provides conditions for obtaining excellent mechanical properties of super duplex stainless steel. Cold working will affect the phase ratio, morphology and distribution of ferrite and austenite. In steel, the ferrite phase forms a dislocation cellular structure through grain slip during cold rolling, while the austenitic phase becomes smaller in grain size, regular in shape and uniform in distribution through mono-series slip and mechanical twins, which is beneficial to further uniform reduction of phase size due to uniform plastic deformation in subsequent cold-rolled pipe processing. The deformation degree of ferritic phase is larger than that of austenitic phase after cold rolling. Therefore, the smaller the two-phase size and the larger the grain boundary area per unit volume. It can disperse the dislocation plugging near the grain boundary, and a greater rolling force is required to push the grain to move to produce plastic deformation. The two-phase size reduction significantly improves the yield strength of steel. Multi-pass deformation is at least 80%, ensuring the size of the recrystallized phase is small after heat treatment.

The deformation of cold rolling passes corresponding to the rolling deformation is at most 35-40%, the diameter reduction is controlled to be 29%-45%, and the wall reduction is controlled to be 26%-48%. The two phases are drawn out in size into a fibrous shape along the deformation direction, the dislocation density gradually increases, the degree of distortion in the structure increases, the degree of grain compression or drawing increases, and the driving force of grain nucleation and growth increases significantly. Sufficient cold rolling deformation improves the uniformity of grains after solution heat treatment.

Physical and chemical test of the grain size of the pipe is carried out before the finished pipe rolling, and the deformation is accumulated through the intermediate product rolling. The cold-rolled pipe of the finished pipe should meet the comprehensive performance requirements of mechanical properties, corrosion properties, shape size, hardness and so on. The deformation of the cold-rolled pipe is relatively small and fine, and the corresponding deformation of the cold rolling pass for rolling deformation corresponding to the deformation extension of the cold-rolled pipe is at most 16-30%. The diameter reduction is controlled to be 10%-42%, and the wall reduction is controlled to be 10%-46%.

The 11-roll straightener was used to stagger V-shaped straightening rollers arranged up and down, and the offset of the upper and lower straightening roller devices is adjusted by deflection angle to be 3.5-5% of the outer diameter of the pipe at the inlet of the 11-roll straightener, and the bending degree of the pipe is controlled to be at most 1 mm/m. The circular saw is used to cut the pipe with high precision, so that the outside of the pipe is perpendicular to the end face, thereby ensuring no gap is formed when the two pipe ends are jointed.

A self-fusion welding+cosmetic circumferential girth welding process is adopted, where preset welding procedure set according to the corresponding brand and specification is selected to automatically weld tungsten electrode heads at the full circumference; the outside of the pipe is protected by a high-purity argon-nitrogen mixture (Ar: 98% and N₂: 2%), and the inside of the pipe is protected by pure N₂. The welding temperature can promote the austenite transformation and protect the pitting resistance of the heat affected zone of the weld. With the help of an oxygen analyzer, the welding process is implemented when the O content is at most 500*10-6. With the drive mechanism, circumferential welding is implemented around the weld, and the self-fusion welding+cosmetic welding combined process is implemented with a welding torch around the circumference of the track along the weld. The proportions of peak value and base value are 200 ms and 300 ms, respectively, and the heat input is controlled to be 0.25-1.35 kJ/min.

After welding, the residual height of the weld and the place where the unclear echo is generated are polished. The width of the polished area is at most 20 mm-40 mm. The belt-sanding planetary system performs 360° accurate polishing on the surface of the weld of the pipe, and the linear speed of the polishing belt is 8-25 m/s. At the end of polishing, the sand belt should be returned to the original position, 20-30 mm away from the pipe, so as to avoid affecting the surface of the pipe if the moving pipe collides with the sand belt.

For the girth weld X-ray inspection, the front and back positions of the pipe are adjusted so that the X-ray focus, the inspected girth weld and the center of a flat detector are on the same axis. An X-ray surround real-time imaging device is used to carry out 360° annular X-ray inspection around the circumference of the pipe. The X-ray penetrates the pipe and is absorbed by the flat detector and converted into a digital signal, and a screen image is then formed by an industrial personal computer and displayed in real time. The inspection personnel determines the quality of the detected weld, automatically forms an inspection report through the quality system, and adopts a take-up reel mechanism to take up the line. If welding defects are found in real-time images, the position, size and nature of the defects are determined and removed for re-welding.

The position at the unqualified weld needs to be cut off and re-welded. A horizontal track shuttling disk saw moves to the corresponding position to be cut, and the cut length on both sides of the weld is at least 50-150 mm, so as to avoid the influence of repeated welding at a heat-affected position of the pipe on the microstructure and properties of the welded joint.

It is necessary to place the coil into a pressure test room. The hydraulic test device is used to carry out the hydraulic test of up to 100 MPa. After the pressure in the pipe reaches a set value, the pressurization port is closed and the static pressure holding is performed. If the pressure drop is less than the allowable value within the specified time, the coil is qualified. If the water pressure is significantly reduced, it is necessary to put the coil under the traction machine and straighten the coil by the high-precision straightener, and then check the leak in the airtight test tank to repair and weld the coil until the coil is qualified. The hydrostatic test is performed on the recoiled pipe again.

SAF2507 super duplex stainless steel ingot is made by EAF+AOD+LF melting +mold injection and is then forged into billet, as shown in Table 1.

TABLE 1
Test result of Chemical composition (Wt/%)

| | Steel pipe | | | | | | | | |
|---|---|---|---|---|---|---|---|---|---|
| | Chemical composition (mass %, the balance of Fe and impurities) | | | | | | | | |
| Number | C | Mn | P | S | Si | Cr | Ni | Mo | N |
| Steel bar | 0.017 | 0.39 | 0.026 | 0.002 | 0.29 | 25.61 | 6.39 | 3.86 | 0.302 |
| | 0.018 | 0.40 | 0.025 | 0.002 | 0.28 | 25.57 | 6.37 | 3.85 | 0.301 |

| Number | O | Sn | As | Sb |
|---|---|---|---|---|
| Steel bar | 0.0027 | 0.0044 | 0.0027 | 0.0024 |
| | 0.0027 | 0.0046 | 0.003 | 0.0021 |

According to the actual measured values of Cr, Mo and N in Table 1, the PREN values are 43.18 and 43.09 according to the formula PREN=% Cr+3.3*% Mo+16*% N.

The test was performed according to Method A in GB/T10561-2005 “Steel—Determination of content of Non-metallic inclusions—micrographic method using standards diagrams”. Test results show that the non-metallic inclusions meet the requirements of ASTM A213/A213M-2021 standard, as shown in Table 2.

TABLE 2
Test results of non-metallic inclusions

| | Description | | | | | | | | |
|---|---|---|---|---|---|---|---|---|---|
| | A | | B | | C | | D | | DS |
| | Sulfides | | Al oxides | | Silicates | | Cyclic oxides | | Monogranular |
| Type | Thin | Thick | Thin | Thick | Thin | Thick | Thin | Thick | spheroids |
| Requirement | ≤1.0 | ≤1.0 | ≤1.0 | <1.0 | ≤1.0 | <1.0 | ≤1.0 | <1.0 | ≤1.5 |
| Sample 1# | 0.5 | 0 | 1 | 0 | 0 | 0 | 0 | 0.5 | 0 |
| Sample 2# | 0 | 0 | 1 | 0 | 0 | 0 | 0 | 0.5 | 0 |

The total of thin inclusions type A, B, C and D: ≤3.0
The total of thick inclusions type A, B, C and D: ≤3.0

The forging is free forged and hot rolled twice and the ingot undergoes longitudinal compression deformation with a compression deformation ratio of ≥3.5. The σ phase in the steel is eliminated. The heating temperature is 1050° C.-1100° C., and the ingot is forged by longitudinal drawing deformation with a drawing deformation ratio of 3.5-5.5. The S32750 stainless steel sample was cut longitudinally. Under the metallographic microscope, according to the phase size of duplex stainless steel, an appropriate multiple is adopted to measure the length and width of all ferrite phases in the field of view. The length and width of ferrite are summarized for numerical statistics, and the invalid values of aspect ratio of ferrite phase less measured in the field of view are excluded. The average values of all the measured values are calculated as the measured values of the aspect ratio of ferrite in the sample, and the aspect ratio of the ferritic phase in the drawing process is controlled to be 2.3.

Each round steel is pierced and rolled by the skew-rolling hot piercing machine to obtain pierced billets with specified wall thickness sizes of φ65 mm and φ90 mm. The pierced billets are 100% subjected to surface visual inspection and polishing to remove various defects on the inner and outer surfaces. The requirements for the outer diameter and wall thickness of the pierced billets after finishing are shown in Table 3.

TABLE 3
Dimension and tolerance of pierced billets

| | S32750 | | | | |
|---|---|---|---|---|---|
| | Requirements for dimension, tolerance and | | | | |
| | straightness of pierced billet (mm) | | | | |
| | Outer | | Wall | | |
| Outer | diameter | Wall | thickness | Single | |
| diameter | tolerance | thickness | tolerance | side ΔS | Straightness |
| φ65 mm | ±2.0 mm | 5.0 mm | ±1.5 mm | ≤1.0 mm | ≤1.5 mm |
| φ90 mm | ±2.5 mm | 8.0 mm | ±2.0 mm | ≤1.5 mm | ≤2.0 mm |

The finished S32750 super duplex stainless steel seamless pipe is cold rolled by a high-precision cold rolling mill. The high precision of equipment ensures the high-precision inner diameter and wall thickness of the pipe. The inner diameter tolerance is controlled to be 0 to +0.1 mm, and the wall thickness tolerance (wall thickness≤1.3 mm) is controlled to be +15% to −6%. Wall thickness tolerance (wall thickness≤1.3 mm) is controlled to be +10% to −6%.

Integrated control of deformation and distribution is key for the pipe subjected to intermediate annealing heat treatment-reasonable distribution of deformation-solution heat treatment of the finished product multi-pass cold rolling plastic processing and elimination of the detrimental σ phase, where the total deformation of cold-rolled pipe is at least 0.8, the temperature of solution heat treatment is controlled to be 1080±10° C., holding time is controlled to be 9-22 min. The two-phase ratio, mechanical properties and corrosion resistance of the finished pipe are improved by cold rolling and solution heat treatment. According to Method B specified in ASTM A370-23 and ASTM A923-23 standards, samples were taken from two ends of the finished stainless steel seamless pipe, and longitudinal sections were applied to tensile samples, as shown in Table 4.

TABLE 4
Test results of mechanical properties and hardness

| Mechanical | Room-temperature drawing | | | Hardness/ |
|---|---|---|---|---|
| properties | R_{P0.2}/MPa | Rₘ/MPa | A/% | HRC |
| Requirement | ≥800 | ≥550 | ≥15 | 22-32 |
| Sample1^{#} | 864 | 684 | 30 | 26/25/26 |
| Sample2^{#} | 855 | 681 | 31 | 26/26/25 |

The ferrite content of a steel bar is determined by dot counting according to ASTM E562 standard. The ferrite content of the SAF2507 super duplex stainless steel seamless pipe is 49.4% by dot counting method in 10 representative fields randomly selected.

The pitting corrosion test was conducted in accordance with Method A in ASTM G48-11 (2020) e1. After grinding, the weight loss before and after corrosion was calculated after soaking in ferric trichloride solution of about 6% (mass ratio) at 50° C. for 24 hours, so as to obtain the corrosion rate. The calculated corrosion rate was 0.34 g/m², and no pitting corrosion was found visually on the specimen surface magnified 20 times, as shown in FIG. 1.

According to the requirements of Method A in ASTM A923-23 “Test Method for Detecting Detrimental Intermetallic Phase in Duplex Austenitic/ferritic Stainless Steels”, the pipe was sampled. After polishing, the sample was electrolysed in 40% sodium hydroxide solution at 1-3V for about 15 s. The eroded surface was observed under a metallographic microscope at 400 times. The phase boundary was an unaffected structure which was smooth without detrimental intermetallic compounds, as shown in FIG. 2.

The difference between Embodiment 2 and Embodiment 1 is that the nitrogen content was 0.291%, and according to the actual measured values of Cr, Mo, and N elements, the PREN values were respectively 42.90 calculated according to the formula PREN=% Cr+3.3*% Mo+16*% N.

The ferrite content was determined by dot counting according to ASTM E562 standard. Ten representative fields of view were randomly selected, and the ferrite content was 50.1% detected by dot counting method.

Provided is a S32750 super ferritic/austenitic duplex seamless stainless steel pipe for a deep-sea manifold and the composition comprises, in mass %: C: 0.018%, Si: 0.28%, Mn: 0.42%, P: 0.021%, S: 0.001%, Cr: 25.57%, Ni: 6.39%, Mo: 3.84%, N: 0.291%, W: 0.01%, Co: 0.056%, Nb: 0.01%, Ti: 0.007%, Al: 0.013%, Ce: 0.01%, B: 0.0027%, O: 25 ppm, Sb: 0.003%, Sn: 0.003%, As: 0.005%, and the balance of Fe and impurities.

The finished S32750 super duplex stainless steel seamless pipe is cold rolled by a high-precision cold rolling mill. The high precision of equipment ensures the high-precision inner diameter and wall thickness of the pipe. The inner diameter tolerance is controlled to be 0 to +0.1 mm, and the wall thickness tolerance (wall thickness≤1.3 mm) is controlled to be +15% to −6%. Wall thickness tolerance (wall thickness≤1.3 mm) is controlled to be +10% to −6%.

Integrated control of deformation and distribution is key for the S32750 super duplex stainless steel seamless pipe subjected to intermediate annealing heat treatment-reasonable distribution of deformation-solution heat treatment of the finished product multi-pass cold rolling plastic processing and elimination of the detrimental σ phase, where the total deformation of cold-rolled pipe is at least 0.8, the temperature of solution heat treatment is controlled to be 1080±10° C., holding time is controlled to be 9-22 min. The two-phase ratio, mechanical properties and corrosion resistance of the finished pipe are improved by cold rolling and solution heat treatment. According to Method B specified in ASTM A370-23 and ASTM A923-23 standards, samples were taken from two ends of the finished stainless steel seamless pipe, and longitudinal sections were applied to tensile samples, as shown in Table 5.

TABLE 5
Test results of mechanical properties and hardness

| Mechanical | Room-temperature drawing | | | Hardness/ |
|---|---|---|---|---|
| properties | R_{P0.2}/MPa | Rₘ/MPa | A/% | HRC |
| Requirement | ≥800 | ≥550 | ≥15 | 22-32 |
| Sample1^{#} | 912 | 715 | 30 | 26/27/27 |
| Sample2^{#} | 904 | 710 | 30 | 26/26/26 |

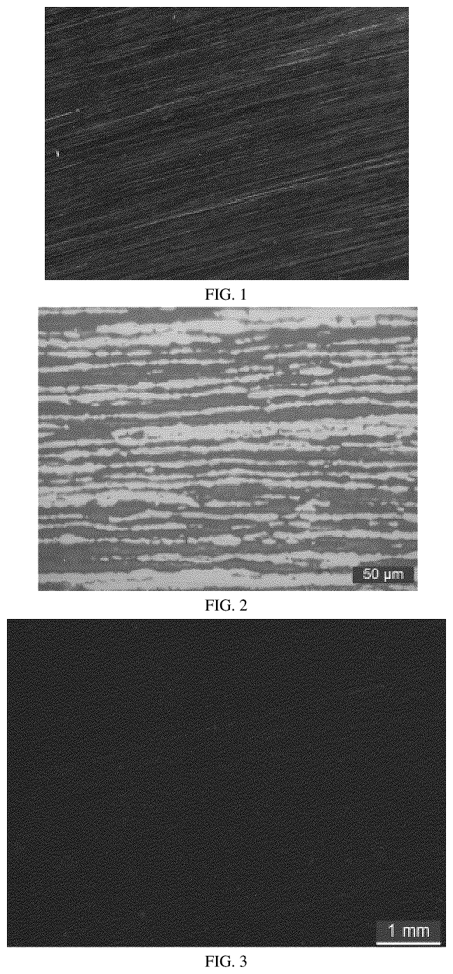

The pitting corrosion test was conducted in accordance with Method A in ASTM G48-11 (2020) e1. After grinding, the weight loss before and after corrosion was calculated after soaking in ferric trichloride solution of about 6% (mass ratio) at 50° C. for 24 hours, so as to obtain the corrosion rate. The calculated corrosion rate was 0.23 g/m², and no pitting corrosion was found visually on the specimen surface magnified 20 times, as shown in FIG. 3.

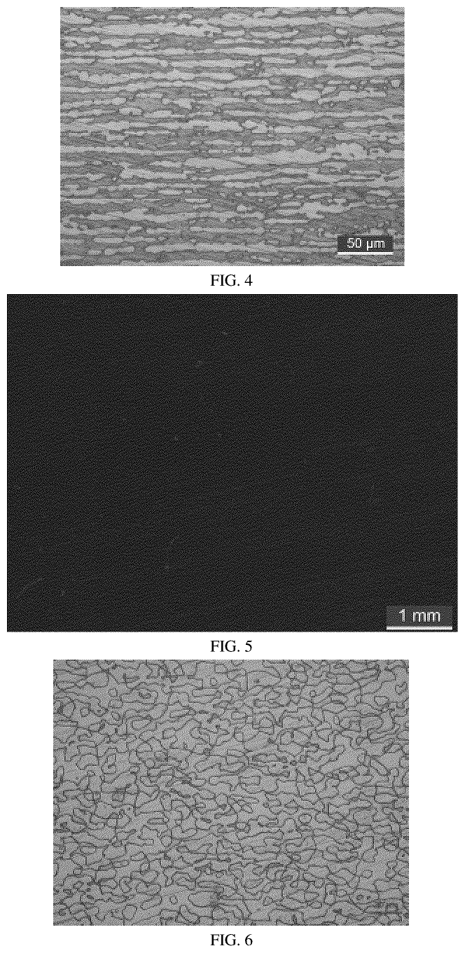

According to the requirements of Method A in ASTM A923-23 “Test Method for Detecting Detrimental Intermetallic Phase in Duplex Austenitic/ferritic Stainless Steels”, the pipe was sampled. After polishing, the sample was electrolysed in 40% sodium hydroxide solution at 1-3V for about 15 s. The eroded surface was observed under a metallographic microscope at 400 times. The phase boundary was an unaffected structure which was smooth without detrimental intermetallic compounds, as shown in FIG. 4.

The difference between Embodiment 3 and Embodiments 1 and 2 is that the nitrogen content was 0.261%, and according to the actual measured values of Cr, Mo, and N elements, the PREN values were respectively 41.52 calculated according to the formula

$$PREN = \% Cr + 3.3 * \% Mo + 16 * \% N .$$

Provided is a S32750 super ferritic/austenitic duplex seamless stainless steel pipe for a deep-sea manifold and the composition comprises, in mass %: C: 0.016%, Si: 0.29%, Mn: 0.39%, P: 0.020%, S: 0.001%, Cr: 25.36%, Ni: 6.16%, Mo: 3.63%, Cu: 0.118%, N: 0.251%, W: 0.016%, Co: 0.27%, Nb: 0.01%, Ti: 0.003%, Al: 0.11%, Ce: 0.01%, B: 0.0021%, O: 24 ppm, Sb: 0.003%, Sn: 0.004%, As: 0.003%, and the balance of Fe and impurities.

The finished S32750 super duplex stainless steel seamless pipe is cold rolled by a high-precision cold rolling mill. The high precision of equipment ensures the high-precision inner diameter and wall thickness of the pipe. The inner diameter tolerance is controlled to be 0 to +0.1 mm, and the wall thickness tolerance (wall thickness ≤1.3 mm) is controlled to be +15% to −6%. Wall thickness tolerance (wall thickness≤1.3 mm) is controlled to be +10% to −6%.

The S32750 super duplex stainless steel seamless pipe is subjected to the key technology of integrated control for intermediate annealing heat treatment-reasonable distribution of deformation-deformation and distribution of multi-pass cold rolling plastic processing in solid solution heat treatment of the finished product and removal of the detrimental σ phase, where the total deformation of cold-rolled pipe is at least 0.8, the temperature of solution heat treatment is controlled to be 1080±10° C., holding time is controlled to be 9-22 min. The two-phase ratio, mechanical properties and corrosion resistance of the finished pipe are improved by cold rolling and solution heat treatment. According to Method B specified in ASTM A370-23 and ASTM A923-23 standards, samples were taken from two ends of the finished stainless steel seamless pipe, and longitudinal sections were applied to tensile samples, as shown in Table 6.

TABLE 6
Test results of mechanical properties and hardness

| Mechanical | Room-temperature drawing | | | Hardness/ |
|---|---|---|---|---|
| properties | R_{P0.2}/MPa | Rₘ/MPa | A/% | HRC |
| Requirement | ≥800 | ≥550 | ≥15 | 22-32 |
| Sample1^{#} | 883 | 677 | 32 | 26/25/26 |
| Sample2^{#} | 879 | 681 | 31 | 26/26/27 |

The ferrite content was determined by dot counting according to ASTM E562 standard. Ten representative fields of view were randomly selected, and the ferrite content was 51.6% detected by dot counting method.

The pitting corrosion test was conducted in accordance with Method A in ASTM G48-11 (2020) e1. After grinding, the weight loss before and after corrosion was calculated after soaking in ferric trichloride solution of about 6% (mass ratio) at 50° C. for 24 hours, so as to obtain the corrosion rate. The calculated corrosion rate was 0.45 g/m², and no pitting corrosion was found visually on the specimen surface magnified 20 times, as shown in FIG. 5.

According to the requirements of Method A in ASTM A923-23 “Test Method for Detecting Detrimental Intermetallic Phase in Duplex Austenitic/ferritic Stainless Steels”, the pipe was sampled. After polishing, the sample was electrolysed in 40% sodium hydroxide solution at 1-3V for about 15 s. The eroded surface was observed under a metallographic microscope at 400 times. The phase boundary was an unaffected structure which was smooth without detrimental intermetallic compounds, as shown in FIG. 6.

SST-40 wireless transmission rotary ultrasonic eddy current integrated joint testing equipment and a pulse reflection ultrasonic testing system were used to carry out longitudinal and transverse ultrasonic testing of the internal and external surfaces according to NB/T20003. The rectangular groove in the standard sample had a depth of 0.1-1.0 mm, a width of not more than 1.6 mm, a length of not more than 12.5 mm. The percent of pass in ultrasonic inspection was higher than 95%. for nominal outer diameter of less than 65 mm, a digital eddy current inspection system was used to carry out longitudinal and circumferential eddy current testing according to NB/T20003 standard. The diameter of the through hole in the standard sample was not greater than 1.5 mm, the cutting groove has a depth of not greater than 0.1 mm, a width of not greater than 1.5 mm and a length of not greater than 25 mm, and the percent of pass in eddy current inspection was 100%.

According to the ASTM E165 standard, the penetration test shall be carried out on the 100% pipe end by not less than 50 mm, and the inspection length shall be as long as possible on the inner surface according to the inner diameter.

All the finished stainless steel seamless pipes were subjected to hydrostatic test according to ASTM A999 standard. Test pressure was calculated according to the formula P=2SR/D. The percent of pass in the hydraulic test was higher than 100%.

The above is schematic description of the invention and its embodiments and the description is not restrictive. What is shown in the drawings is only one of the embodiments of the invention, and the actual structure is not limited thereto. Therefore, where those of ordinary skill in the art are inspired by the invention to structural modes and embodiments similar to the technical solution, without deviating from the concept of the invention, without creative work, all the structural modes and embodiments shall fall within the scope of the invention.

What is claimed is:

1. A preparation method for a welded and extended super duplex stainless steel seamless pipe coil for a deep-sea umbilical cable, comprising the following steps:
S1. adding alloying elements to an S32750 super ferritic/austenitic stainless steel base, controlling the composition of liquid steel through triple stripping pretreatment of hot metal and initial refining in an electric arc furnace to produce a qualified molten stainless steel;
S2. in argon-oxygen refining in an AOD furnace, performing an oxidation reaction to raise the furnace temperature, adding ferrochrome to adjust the composition, adding ferrosilicon during a reduction period to remove CaO+MgO+Al₂O₃+SiO₂ slag from the steel, performing a decarbonization reaction to remove carbon to 0.03% or below so that the composition of liquid steel is stable; adding aluminum powder to the slag surface to perform deoxidation so that O element exists in the liquid steel in the form of Al₂O₃ inclusion;
preparing high-alkalinity refining slag, and performing calcium treatment for optimization so that Al in the Al₂O₃ inclusion is replaced by Ca and enters the liquid steel without generating AlN, and the hard non-deforming Al₂O₃ inclusion is transformed into a plastic calcium aluminate inclusion with a low melting point, wherein the principle of calcium treatment is to generate 12CaO·7 Al₂O₃ as a liquid inclusion, without the formation of solid CaS inclusion;
S3. in LF external refining, performing slight argon stirring, adding the high-content MgO+Al₂O₃ slag and performing deoxidation with aluminum powder to form a high-alkalinity atmosphere, and then further adsorbing inclusions in the liquid steel, and finally casting an ingot by using the liquid steel, wherein the ferrite content in the ingot is controlled to be 45%-56%;
S4. heating the ingot first, and then performing longitudinal compression on a high-speed forging press followed by transverse compression, so that the ingot is longitudinally compressed with a compression deformation ratio of at least 1; after the ingot is forged at least twice on the high-speed forging press, rolling the ingot on a bar hot rolling mill to finally obtain a round billet, wherein the total forging deformation ratio is at least 3.5, the longitudinal drawing deformation ratio is 3.5-5.5, and the total transverse deformation ratio/total longitudinal deformation ratio is 0.30-0.50, and austenitic phase, and the aspect ratio of the austenitic phase is controlled to be 1.0-3.0;
S5. drilling positioning holes at the center of the round billet, wherein the piercing deformation temperature is 1080° C.-1200° C., the temperature-rise heating time is 150-290 min, and the soaking and holding time is 15-40 min, a high piercing deformation rate weakens the strain distribution effect and increases the dislocation density in the austenitic phase, the piercing rate of super duplex stainless steel can be increased to promote dynamic recrystallization; after piercing, the billet is rapidly cooled with water so that the volume fraction of detrimental σ phase in steel is controlled to be at most 0.2%;
S6. performing cold rolling and solution heat treatment, wherein in a cold-deformation plastic processing process, the deformation of the pony-roughing pass cold-rolled pipe is at most 35-40%, the temperature of solution heat treatment is 1100±10° C., and the holding time is 10-25 min; performing a precision large-deformation cold rolling process on a finished product, wherein the deformation of the cold rolled pipe is at most 16-30%, the temperature of solution heat treatment is 1080±10° C., and the holding time is 9-22 min; the accumulation of the total deformation of the cold rolled pipe is at least 80%, and the phase ratio is accurately controlled, the ferrite content is controlled to be 49-52%, and the detrimental σ phase in the steel is eliminated; and
S7. performing a self-fusion welding and cosmetic circumferential girth welding process, wherein the outside of the pipe is protected by a high-purity argon-nitrogen mixture (Ar: 98% and N2: 2%), and the inside of the pipe is protected by pure N₂; and carrying out polishing and testing, thus obtaining a welded and extended super duplex stainless steel seamless pipe coil.

2. The preparation method for a welded and extended super duplex stainless steel seamless pipe coil for a deep-sea umbilical cable according to claim 1, wherein in step S2, in the oxidation stage of AOD furnace smelting, oxidation reaction is performed by large-flow pure oxygen blowing to raise the temperature in the furnace, and the composition adjustment is performed by adding the ferrochrome; when the decarbonization is completed, ferrosilicon is added during the reduction period, and chromium in the slag is reduced into the liquid steel, so that the CaO+MgO+Al₂O₃+SiO₂ slag formed in the liquid steel is removed; then, the decarbonization reaction is performed, wherein the gas introduced into the furnace is nitrogen and oxygen, the flow ratio of nitrogen to oxygen is 3:1, the mass fraction of carbon is reduced to 2×10⁻⁴ or below, and the nitrogen is blown to remove carbon to 0.03% or below; O contained in the liquid steel mainly exists in the form of FeO, MnO, SiO₂, Al₂O₃ and other inclusions, deoxidation with aluminum pellets and deoxidation with aluminum powder added on the slag surface are performed to form Al₂O₃ inclusion in the liquid steel, thereby greatly increasing the quantity of Al₂O₃ inclusion in the liquid steel; to ensure the high alkalinity in the refining slag, the composition of the refining slag is adjusted to be: Cao 55%-70%, SiO₂ 10%-20%, and Al₂O₃15%-20%.

3. The preparation method for a welded and extended super duplex stainless steel seamless pipe coil for a deep-sea umbilical cable according to claim 1, wherein in step S3, in the LF external refining process, slight argon stirring is performed, high-content MgO+Al₂O₃ slag is added and deoxidized with aluminum powder to form inclusions with high alkalinity, deep desulfurization is then performed to further adsorb inclusions in the liquid steel; the argon stirring in the furnace drives the circulation of liquid steel to produce bubbles to remove small-size inclusions; the size of inclusions in the liquid steel is controlled to be 15 μm or below and the quantity of inclusions is significantly reduced; the composition of inclusions is also changed from complex inclusions to pure Mg—Al spinel inclusions, and the inclusions become fine and dispersed; as the time of slight argon stirring increases, the O content in steel gradually decreases; after the time of argon stirring reaches 15 min, the O content decreases slowly due to the slight argon stirring; the time of slight argon stirring is controlled to be 17-23 min, so that the Al content in the steel is controlled to be at most 0.03% and the oxygen content is controlled to be at most 25 ppm.

4. The preparation method for a welded and extended super duplex stainless steel seamless pipe coil for a deep-sea umbilical cable according to claim 1, wherein in step S4, after the initial forging, the ingot is reheated in a natural gas chamber furnace, wherein the heating time is controlled to be 270±30 min, the temperature is controlled to be 1080° C.-1120° C., and the holding time is controlled to be 30-50 min; the ingot forged twice is reheated in a hot rolling heating furnace, wherein the heating time is controlled to be 200±20 min, the heating temperature is controlled to be 1050° C.-1100° C., and the holding time is controlled to be 15-25 min; the ingot undergoes longitudinal compression deformation on a bar mill with a compression deformation ratio of at least 1.5, and then rapidly cooled with water to room temperature, thus obtaining a steel bar.

5. The preparation method for a welded and extended super duplex stainless steel seamless pipe coil for a deep-sea umbilical cable according to claim 1, wherein in step S5, when the temperature of the temperature rise stage of an inclined-bottom heating furnace is less than 800° C., the round billet is heated slowly; the temperature distribution along the cross section and length direction of the billet is more uniform by extending the heating time and increasing the turning frequency of the round steel blank; in the high-temperature heating stage, the required temperature is reached by rapid heating.

6. The preparation method for a welded and extended super duplex stainless steel seamless pipe coil for a deep-sea umbilical cable according to claim 1, wherein in step S6, the temperature of solution heat treatment is at most 1100° C.; the deformation of cold rolling pass is at most 16-40%, softening is performed by the pony-roughing multi-pass cold rolling process and the intermediate solution heat treatment to obtain a large amount of deformation, the temperature of heat treatment process is controlled to be 1100±10° C., and the holding time is controlled to be 10-25 min; the solution heat treatment temperature of the finished product is controlled to be 1080±10° C., and the holding time is controlled to be 9-22 min; the preheating and temperature rise of 320-955° C. is achieved by improving the heat cycle of a furnace temperature field, and the heating rate is controlled to be 2-2.5° C./s, thereby reducing the quantity of σ and Cr₂N phase precipitated in the steel.

7. The preparation method for a welded and extended super duplex stainless steel seamless pipe coil for a deep-sea umbilical cable according to claim 6, wherein in step S6, for the pony-roughing pass cold-rolled pipe, The deformation of cold rolling passes corresponding to the rolling deformation is at most 35-40%, the diameter reduction is controlled to be 29%-45%, and the wall reduction is controlled to be 26%-48%; the corresponding deformation of the cold rolling pass for rolling deformation corresponding to the deformation extension of the finished cold-rolled pipe is at most 16-30%, the diameter reduction is controlled to be 10%-42%, and the wall reduction is controlled to be 10%-46%.

8. The preparation method for a welded and extended super duplex stainless steel seamless pipe coil for a deep-sea umbilical cable according to claim 1, wherein in step S7, with the help of an oxygen analyzer, the welding process is implemented when the O content is at most 500*10-6, the proportions of peak value and base value are 200 ms and 300 ms, respectively, and the heat input is controlled to be 0.25-1.35 KJ/min.

9. The preparation method for a welded and extended super duplex stainless steel seamless pipe coil for a deep-sea umbilical cable according to claim 8, wherein in step S7, after welding, the residual height of the weld and the place where the unclear echo is generated are polished, wherein the width of the polished area is at most 20 mm-40 mm; a belt-sanding planetary system performs 360° accurate polishing on the surface of the weld of the pipe, and the linear speed of a polishing belt is 8-25 m/s.

10. The preparation method for a welded and extended super duplex stainless steel seamless pipe coil for a deep-sea umbilical cable according to claim 1, wherein the composition of the welded and extended super duplex stainless steel seamless pipe coil comprises, in mass %: C: ≤0.030%, Mn: ≤1.00%, Si: ≤0.75%, P: ≤0.025%, S: ≤0.003%, Ni: 6.0-8.0%, Cr: 24.0-26.0%, Mo: 3.5-4.5%, N: 0.26-0.31%, W: ≤0.03%, Co: ≤0.06%, Nb: ≤0.03%, Ti: ≤0.10%, Al: ≤0.03%, Ce: ≤0.03%, B: ≤0.003%, O: ≤25 ppm; and impurity composition comprises, in mass %: Sb: ≤0.005%, Sn: ≤0.005%, and As: ≤0.01%;
the equivalent formula for the ferrite forming element Cr of the welded and extended super duplex stainless steel seamless pipe coil is expressed as Creq=Cr %+0.9*Mo %+1.5*Si %+0.5*Nb %+1.0*Ti %+2.5*A1%+0.5*W %, and the equivalent formula for the austenite forming element Ni is expressed as
$$Ni eq = Ni \% + 1 * Co \% + 14.7 * N \% + 30 * C \% + 0.5 * Mn \% + 0.3 \times Cu \% .$$
